(19) United States
(12) Patent Application Publication
(10) Pub. No.: US 2016/0302369 A1
(43) Pub. Date: Oct. 20, 2016

(54) AUTOMATED HYDROPONIC GROWING AND HARVESTING SYSTEM FOR SPROUTS WITH A PADDLE-EQUIPPED LINEAR SEED HEAD

(71) Applicant: Snowbird Environmental Systems Corporation, Jacksonville, FL (US)

(72) Inventors: John Middleton Pickell, South Haven, MI (US); Larry Paul Prater, Taylor, MI (US)

(73) Assignee: Snowbird Environmental Systems Corporation, Jacksonville, FL (US)

(21) Appl. No.: 15/198,355

(22) Filed: Jun. 30, 2016

Related U.S. Application Data
(63) Continuation-in-part of application No. 14/642,738, filed on Mar. 9, 2015, now abandoned.

(51) Int. Cl. A01G 31/04; A01G 7/04

(52) U.S. Cl. CPC A01G 31/045; A01G 7/045

(57) ABSTRACT

An automated hydroponic growing and harvesting system for sprouts includes a continuous serpentine chain conveyor transporting suspended trays through a tray preparation zone where trays are cleaned, a seeding zone where a layer of seeds is deposited across each tray, a germination zone where environmental conditions and nutrients and water are provided for germination, a growing zone where lighting, nutrients and water are provided for growth, and a harvesting zone where sprouts are dumped from each tray.

### RELATED APPLICATION

This application is a continuation in part of and claims the benefit of priority of U.S. nonprovisional application Ser. No. 14/642,738 filed 9 Mar. 2015, which is a nonprovisional of and claims the benefit of priority of U.S. Provisional Application 61/967,053 filed 10 Mar. 2014, the entire contents of which are incorporated herein by this reference and made a part hereof.

### FIELD OF THE INVENTION

This invention relates generally to growing fodder, and, more particularly, to a hydroponic system for automatically growing and harvesting sprouts, such as sprouted grasses and legumes, from seeds.

### BACKGROUND

Hydroponic fodder systems have been devised to sprout cereal grains, such as barley, oats, wheat, sorghum, and corn, or legumes, such as alfalfa, clover, or cow peas. Barley is a commonly grown forage, because it usually provides a good yield of nutrients.

A hydroponic fodder system usually consists of a framework of shelves on which metal or plastic trays are stacked. After soaking overnight, a layer of seeds is spread over the base of the trays. During the growing period, the seeds are kept moist, but not saturated. They are supplied with moisture and (sometimes) nutrients, usually via drip or spray irrigation. The seeds will usually sprout within 24 hours and in 5 to 8 days have produced a 6 to 8 inch high grass mat. After the mat is removed from the tray, it can go into a feed mixer or otherwise be fed to livestock.

While such hydroponic systems are advantageous, they have shortcomings. First they require significant continuous labor to arrange and prepare trays, to apply seeds, to move the trays to various zones for germination, growth and harvesting, and to harvest the sprouts. Second, seeds are frequently wasted by being applied in multiple layers, where the upper layers retard or prevent growth of lower layers. Third, resources such as water and nutrients are frequently applied in excess and not effectively captured for recycling.

The invention is directed to overcoming one or more of the problems and solving one or more of the needs as set forth above.

### SUMMARY OF THE INVENTION

To solve one or more of the problems set forth above, in an exemplary implementation of the invention, an automated hydroponic growing and harvesting system for sprouts includes a continuous serpentine chain conveyor transporting suspended trays through a tray preparation zone, a seeding zone, a germination zone, a growing zone and a harvesting zone. Each zone occupies a portion of the conveyor and comprises a portion of the system. At the tray preparation zone, trays are cleaned and prepared for seeding. At the seeding zone, a layer of seeds is applied to each prepared tray. At the germination zone, the seeds are supplied determined amounts of water and nutrients while being maintained in environmental conditions favorable for germination. At the growing zone, light, water and nutrients are provided, while being maintained in environmental conditions favorable for growth. At the harvesting zone, sprouts are dumped from trays onto a conveyor or chute for storage and use. After the harvesting zone, the trays automatically proceed to the tray preparation zone.

An exemplary system according to principles of the invention includes all drives, sensors, environmental equipment, and controls necessary to continuously grow and harvest the seeds with little to no labor. The system is scalable and adaptable.

Unlike conventional greenhouse growing methods, which are labor, time and space consuming processes, an automated system according top principles of the invention provides a compact and organized approach that can be packaged into a self-sustaining container or enclosure, supplied with water, nutrients and HVAC equipment and electric power.

In one exemplary embodiment, a hydroponic system for automatically growing and harvesting sprouts, includes a framework with a left side and a right side. A first chain is driven in a first serpentine path along one of the left side and right side. A second chain, parallel to the first chain, is driven in a second serpentine path along the opposite side. The second serpentine path is a mirror image of the first serpentine path. Each chain is a continuous chain. A plurality of first and second side chain rails and sprockets define each portion of the first and second serpentine paths. A plurality of trays are operably coupled to the first chain and second chain. Each tray is substantially parallel to each other tray, between the left side and right side of the framework, and spaced apart from each other tray. Each tray is operably coupled to the first chain and second chain by being hooked onto a pair of support pins, one support pin attached to and extending from each chain, and the support pins being aligned and defining an axis about which the tray may pivot. each support pin extending from the first chain. Movement of each chain along the serpentine path causes movement of each hooked tray along the serpentine path.

Each tray includes a first side and an opposite second side. The first side is at a higher elevation than the second side. Thus, the tray is inclined. The tray may include at least one drainage aperture at the lower (second) side.

A motor operably coupled to a drive shaft includes a first drive sprocket and a second drive sprocket. The first chain is trained over the first drive sprocket and driven by the first drive sprocket. The second chain is trained over the second drive sprocket and driven by the second drive sprocket in unison with the first chain driven by the first drive sprocket.

The serpentine path includes a seeding zone. A seed head automatically deposits seeds on each tray as the tray passes through the seeding zone. The seed head moves between the first side of each tray and the second side of each tray while the tray is in the seeding zone. As the seed head moves, it deposits a layer of seeds on the tray. The seed head may include one or two paddles, each of which is movable from a raised position to a lowered position. The lowered position defines a seeding space between each tray in the seeding zone and the paddle. The seeding space allows deposition and spreading of a layer of seeds on the tray. The seeding zone thus deposits seeds in a tray using a seeding head, and automatically does so with a linearly moving seeding head positioned above the tray, and maintains a substantially single layer of deposited seed by extending at least one paddle downwardly from the seeding head toward the surface of the tray, with a difference between the free end of the paddle and the surface of the tray on which seed is deposited being about the height of a single layer of deposited seed.

The serpentine path includes a germination zone. At least one nozzle in the germination zone delivers a liquid nutrient to each tray as the tray passes through the germination zone. A plurality of containers of nutrients fluidly coupled to the nozzle and supplied to the nozzles by a pump or pressure. Electric lights may be provided in the germination zone.

The serpentine path includes a growing zone. At least one nozzle in the growing zone delivers a liquid nutrient to each tray as the tray passes through the growing zone. A plurality of containers of nutrients fluidly coupled to the nozzle and supplied to the nozzles by a pump or pressure. Electric lights may be provided in the growing zone.

The serpentine path includes a harvesting zone. A tipping device causes each tray to tip as the tray passes through the harvesting zone. Upon tipping the tray drops any sprouts from the tray. A chute, conveyor or receptacle receives sprouts dropped from each tray in the harvesting zone.

The serpentine path includes a tray preparation zone where the tray is tipped and a cleaning head delivers a cleaning liquid (e.g., water with or without a cleaner) to each tray when the tray is tipped in the preparation zone. A receptacle may collect cleaning liquid dripped from each tray when the tray is tipped in the preparation zone. The collected liquid may be recycled or safely disposed.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a front view of a schematic for an exemplary hydroponic system for automatically growing and harvesting sprouts, according to principles of the invention; and

FIG. 2 is a profile view of a schematic for an exemplary hydroponic system for automatically growing and harvesting sprouts, according to principles of the invention; and

FIG. 3 is a first view of an exemplary tray assembly for a hydroponic system for automatically growing and harvesting sprouts, according to principles of the invention; and

FIG. 4 is a second view of an exemplary tray assembly for a hydroponic system for automatically growing and harvesting sprouts, according to principles of the invention; and

FIG. 5 is a first exploded view of an exemplary tray assembly for a hydroponic system for automatically growing and harvesting sprouts, according to principles of the invention; and

FIG. 6 is a second exploded view of an exemplary tray assembly for a hydroponic system for automatically growing and harvesting sprouts, according to principles of the invention; and

FIG. 7 is a first view of components of tray preparation and seeding zones for a hydroponic system for automatically growing and harvesting sprouts, according to principles of the invention; and

FIG. 7A is a second view of components of tray preparation and seeding zones for a hydroponic system for automatically growing and harvesting sprouts, according to principles of the invention; and

FIG. 8 is a third view of components of tray preparation and seeding zones for a hydroponic system for automatically growing and harvesting sprouts, according to principles of the invention; and

FIG. 9 is a schematic of an exemplary seeder for a hydroponic system for automatically growing and harvesting sprouts, according to principles of the invention; and

FIG. 10 conceptually illustrates a seed head over a prepared tray onto which the seed head will deposit a layer of seeds as the seed head traverses the tray; and

FIG. 11 conceptually illustrates a seed head with no paddles deployed (i.e., lowered) in configuration A, with one paddle deployed (i.e., lowered) in configuration B; and both paddles deployed in configuration C.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

An exemplary automated hydroponic growing and harvesting system for sprouts according to principles of the invention includes a continuous serpentine chain conveyor transporting suspended trays through a tray preparation zone, a seeding zone, a germination zone, a growing zone and a harvesting zone. Each zone occupies a portion of the conveyor path and comprises a portion of the system. At the tray preparation zone, trays are automatically cleaned and prepared for seeding. At the seeding zone, a layer of seeds is automatically applied to each prepared tray. At the germination zone, the seeds are automatically supplied determined amounts of water and nutrients while being maintained in environmental conditions favorable for germination. At the growing zone, light, water and nutrients are provided, while the sprouts are maintained in environmental conditions favorable for growth. At the harvesting zone, grown sprouts are dumped from trays onto a conveyor or chute for storage and use. After the harvesting zone, the trays automatically proceed to the tray preparation zone, where the cycle continues.

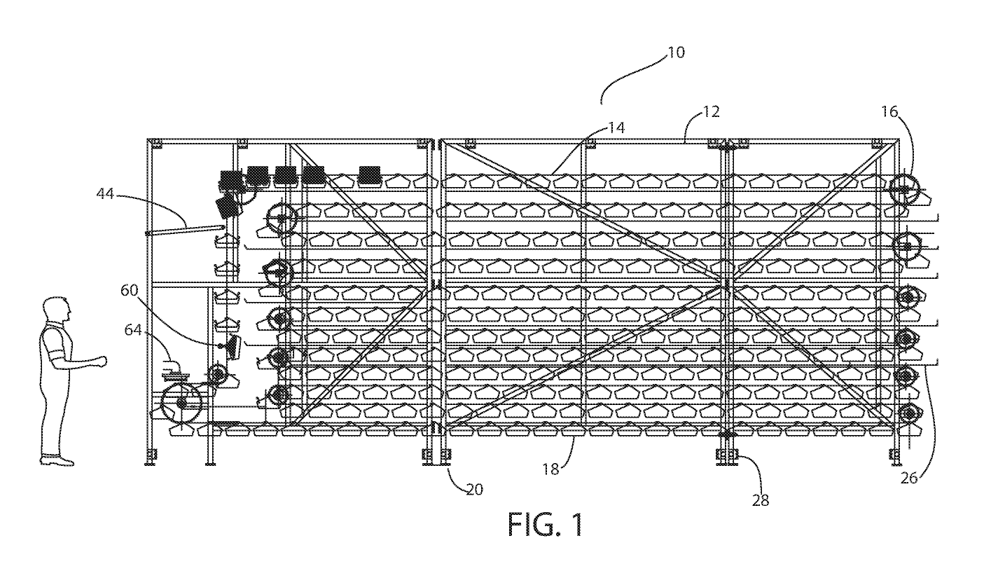

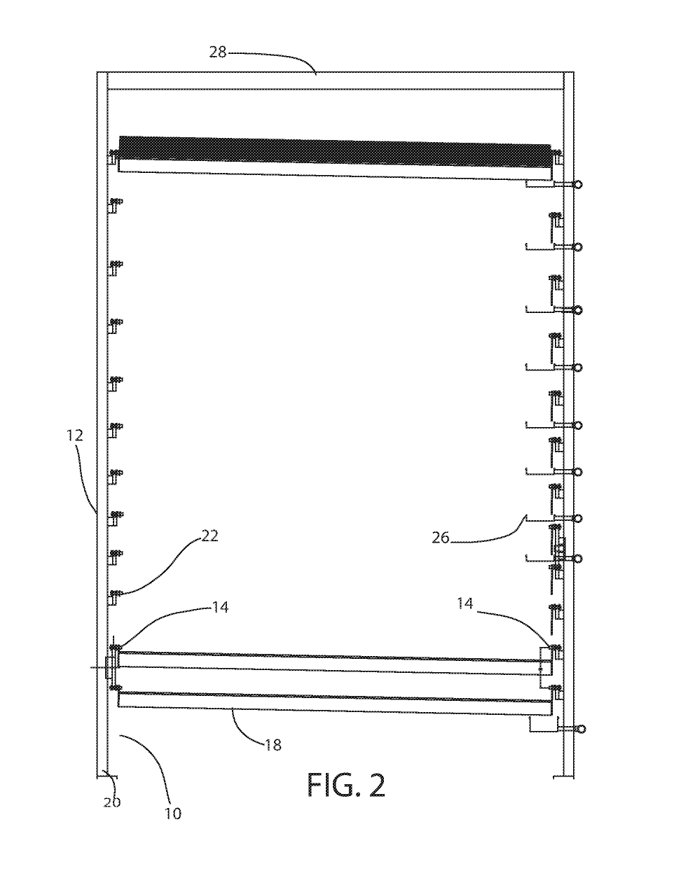

Referring now to FIG. 1, a schematic for an exemplary hydroponic system 10 for automatically growing and harvesting sprouts, according to principles of the invention, is provided. The system 10 includes a frame 12 for support, multiple feet 20, upper and lower frame connectors 28, chain 14 and sprockets 16. The chain 14 moves through a serpentine path through the frame 12. The frame 12 has left and right hand sides that are opposite and opposing (as illustrated in FIG. 2). The two frame 12 sides are connected by upper and lower frame connectors 28. Thus, the frame 12 is a framework of structural elements that support the chain rails 22 and sprockets 16 over which the chain 14 travels in a serpentine path.

The system 10 is scalable. The system 10 may be sized and shaped to fit within an enclosed, environmentally controlled space, such as, but not limited to, a greenhouse, factory, garage, shed or the like. A plurality of systems 10 may be implemented to achieve a desired output.

Carriages 18 are suspended from a chain 14 for transport along a multilayer serpentine path through the frame 10. The chain 14 is endless and continuous. The carriages 18 are hooked onto support pins attached to the chain 14. A plurality of spaced apart parallel chain rails 22 (FIG. 2) provide generally planar supports to guide a segment of each chain along each layer of the serpentine path. The carriages 18 of the system 10 are connected to the chain 14, and the chain 14 slides along the chain rail 22 and around the chain sprockets 16. Thus, the carriages 18 are transported by the chain sliding along the rails.

The carriages 18 are generally maintained upright while being transported. The center of mass of each carriage 18 is below the support pins when the carriages are freely suspended. Except when the carriages 18 are intentionally inverted by components of the system such as during harvesting and preparation, the carriages 18 remain upright as the chain 14 transports the carriages 18 along the serpentine path through the zones. Carriages 18 may be tipped upside down by urging the carriages to pivot about the support pin.

In a preferred implementation, a chain 14 is provided on each side of the frame 10. In such an embodiment, each side of a carriage is suspended from a chain and the chains move in unison on chain rails 22 through the serpentine path.

With reference to FIG. 2, each layer of the serpentine path is spaced in proportion to the next vertical layer. The chain rails 22 provide generally planar left side and right side supports to guide a segment of the chain along each layer of the serpentine path. The rail on one side of the frame 12 (e.g., on the left side of the frame 12) for a layer may be higher than the rail on the opposite side of frame for the same layer of the serpentine path, to support the carriage 18 at an incline. Thus, each layer (or one or more layers) may be inclined. An incline facilitates the flow of water and nutrients from one side of the carriage to the opposite side of the carriage, where any excess water or nutrients may then be drained through drainage apertures. Drained water may be recovered and recycled for repeated use in the system. Liquids applied at one side of the carriage will flow to the opposite side of the carriage. In doing so, all seeds or sprouts are nourished. Thus, any layer that may receive liquid water and/or nutrients may benefit from an incline.

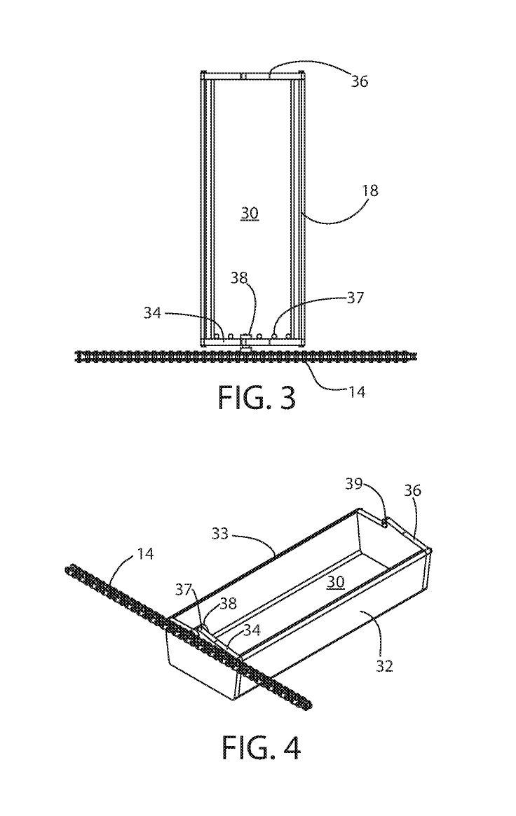

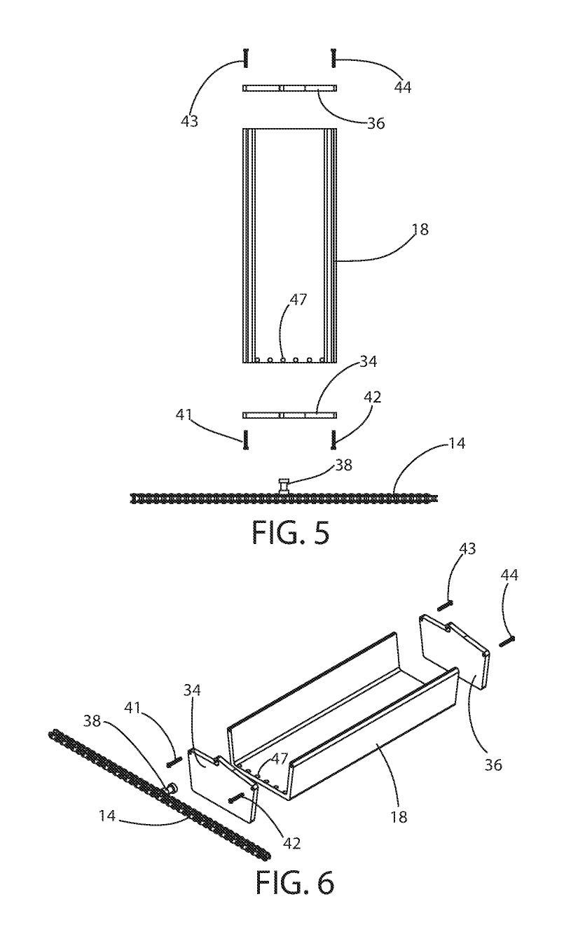

Now with reference to FIGS. 3 through 6, views of an exemplary carriage 18 are provided. The length of the carriage, measured from side 34 to opposite side 36 may be any length that fits a frame 12 according to the invention. The depth and width may be varied to accommodate a frame configuration and growth. Each side 34, 36 includes a hook 37, 39 for engaging a support pin 38 attached to a chain 14, e.g., passing through a chain link. The carriage side plates 34 and 36 rest on the opposing pivot pins 38 and allow the carriage 18 to freely pivot as the carriage 18 moves with the chain 14, which is supported by the chain rails 22 and the sprockets 16, allows the change in direction of the carriages 18 as they move through the growing system. Attachments 41, 42, 43, 44 connect the sides 34, 36 to the front and back panels 32, 33 of the tray 30. The tray 30 may be a removable pan. Drainage apertures 47 may be provided in the tray 30.

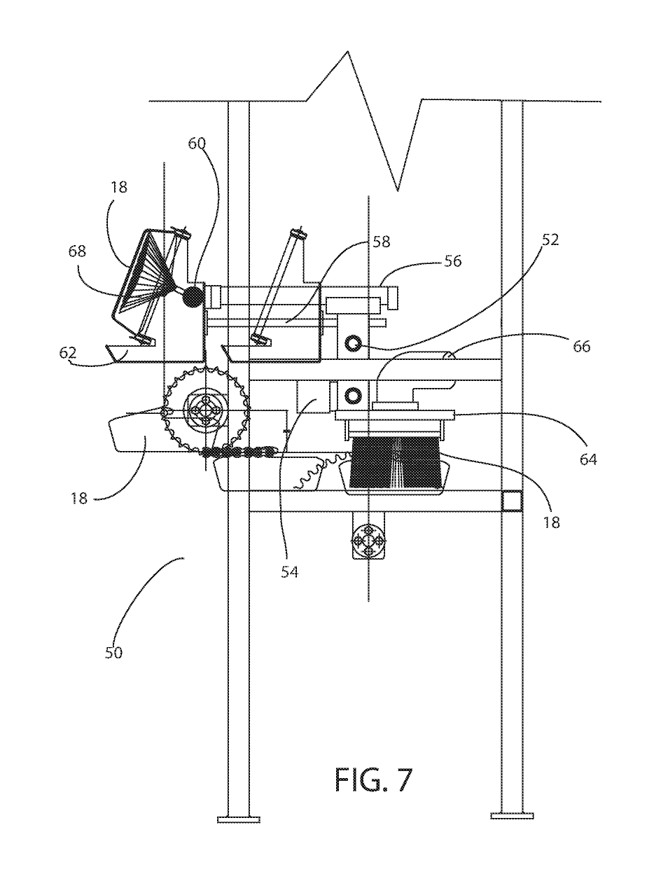

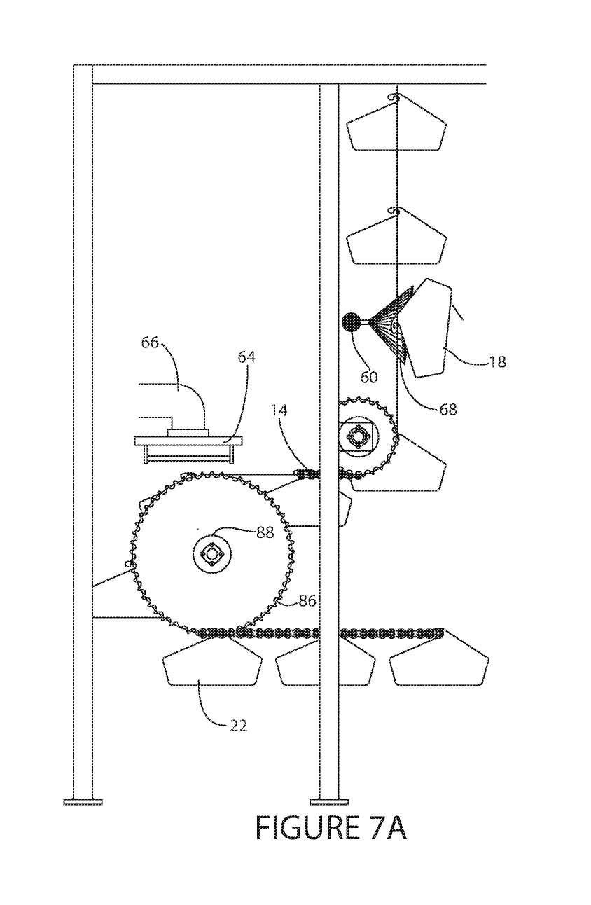

Referring now to FIGS. 7, 7A, 8 and 9, a wash and seed mechanism 50, that cleans the removable tray 30 of the carriage 18, and applies the seed to the removable tray 30 is conceptually illustrated. The wash and seeding mechanism 50 moves form side to side along guide bars 52 by a rodless cylinder 54 (or other linear actuator) in such a manner as to cover the complete length of each carriage 18 from side 34 to side 36. The wash head 60 is moved by a second rodless cylinder 56 that moves along guide bars 58, and carries a drip pan 62 as it extends to wash position. The carriage 18 that is at this position will rotate on the pivot pins 38 to an angle sufficient for cleaning the removable tray 30. The spray head 60 applies cleaning solution 68 to the inverted carriage 18 and the spent solution 68 together with any residual is collected in the drain pan 62 and is removed for post processing. Both the wash head 60 and the seed head 64 move linearly along the guide bars 52 as a connected assembly.

A seed supply 66 is connected to the seed head 64 and moves laterally on the guide bars 52 so that the seed is distributed inside the tray 30 of the carriage 18 as each and every carriage is positioned to this zone. The seed head 64 deposits seeds on the tray 30 of the carriage 18. In an exemplary implementation, the seed head deposits a single layer of seeds covering substantially the entire area of the tray 30 of the carriage 18. As the exposed (uppermost) seeds tend to germinate and sprout while the lower seeds do not, a single layer avoids seed waste.

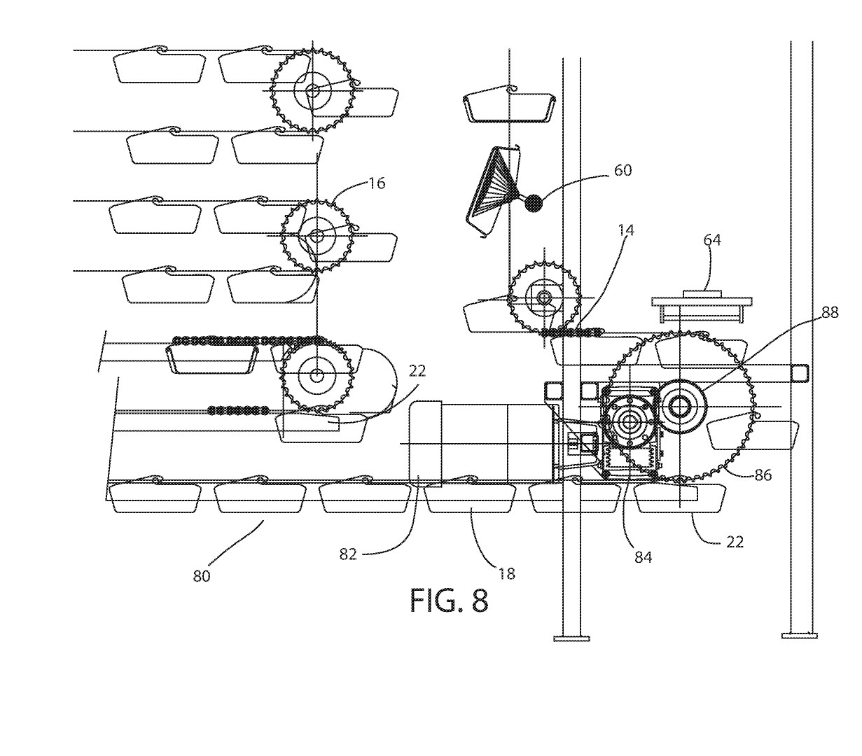

Referring now to FIG. 8 there is shown an exemplary drive system 80 that propels the chain 14 and the multiple carriages 18, each carriage having a removable tray 30 through the serpentine path created by the multiple sprockets 16 and the drive sprockets 86. An electric motor 82 drives a reducer 84 which in turn rotates a main drive shaft 88. The main drive shaft 88 has a sprocket 86 on each end that engages to the chains 14 on each side of the frame 12. This drive system 80 ensures that the chains 14 remain in synchronous motion as they move through their serpentine path, and ensures that the carriages 18 remain in their linear position relative to each other.

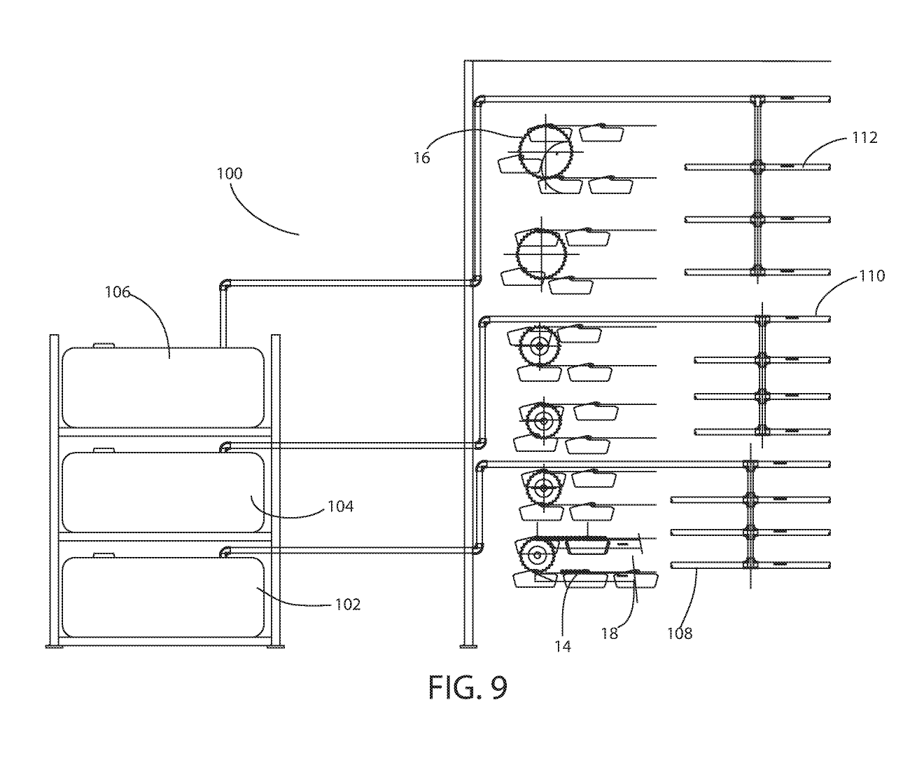

Referring to FIG. 9 there is shown the nutrient supply 100 including three separate holding tanks, 102, 103, and 104. Each of the tanks, 102,103, and 104 have a supply pump 114 and supply lines 108, 110, and 112 that apply the nutrient solution to their respective zones. A combination of nutrients and water to promote germination and growth are provided at the germination and growing zones, respectively. The contents, concentrations, volumes and frequencies of the supplied nutrient may be varied for the particular seeds and sprouts being grown.

Lighting may be supplied by lights positioned within the frame 18 of the system at one or more zones of the serpentine path, such as the germination zone and the growing zone, particularly the growing zone. Such lights may comprise LED, high pressure sodium or other lights suitable for stimulating germination and plant growth. Lighting may be provided periodically to allow nighttime conditions conducive to plant growth. Natural light may be supplied in lieu of or in addition to electric lighting. By way of example, the system may be enclosed in a greenhouse or other structure which receives natural lighting.

At harvesting, the carriage 18 is tipped or inverted, causing the sprouts to fall to a conveyor or chute 44. Tipping may be caused by a fixed obstacle in the path of the tray and/or a rotary or linear actuator, such as a solenoid, or another actuation device. Because the sprouts are grown without growing media, primarily only the grown sprouts (whether fully or partially grown) and any un-grown seeds are deposited at the harvesting zone. If the sprouts adhere to the tray, the carriage may be impacted, vibrated or scraped to facilitate discharge of the sprouts.

The construction details of the system as shown in FIGS. 1 through 9 are composed of metals, plastics, and any other sufficiently rigid and strong materials. The system should be strong, durable, water and chemical resistant and suitable for use in growing environments.

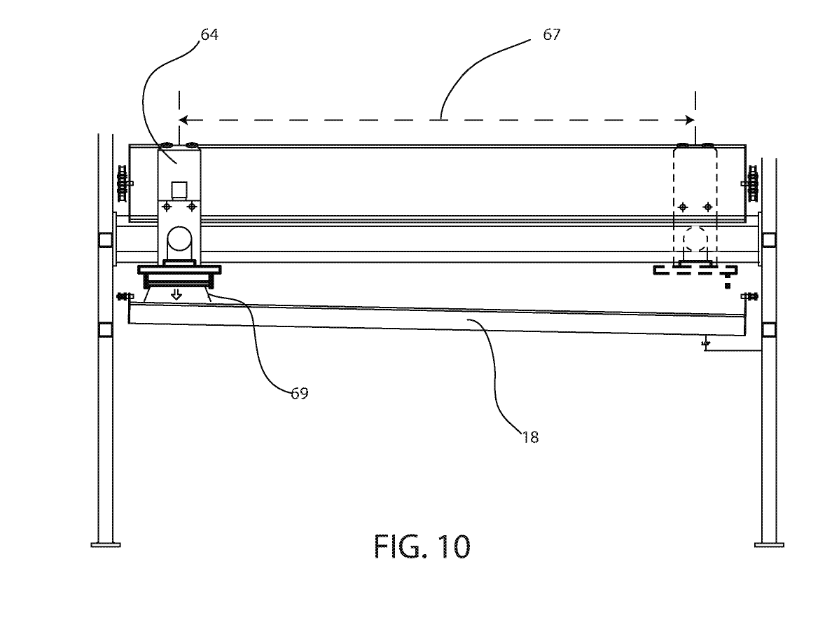

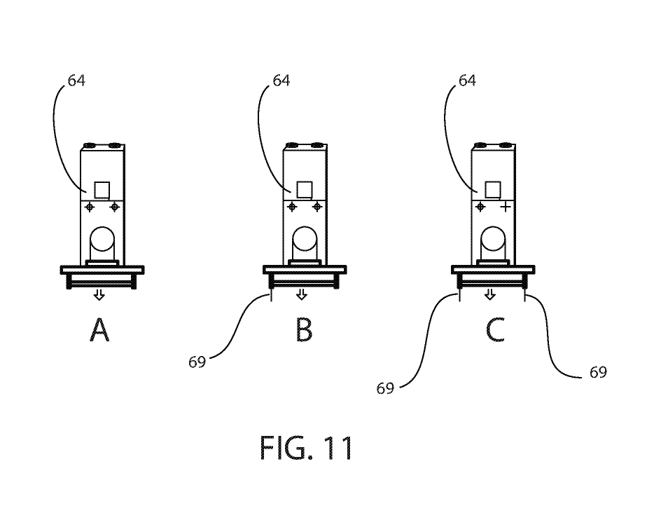

FIGS. 10 and 11 illustrate an exemplary seed head 64. The seed head 64 deposits seed on the tray 30. The seed head moves linearly from one side of the frame to the other side, as shown by stroke 67 in FIG. 10, covering the entire length of the tray 30 of the carriage 18. The exemplary seed head 64 includes a pair of spreader paddles 69. The spreader paddles 69 are movable from a raised position to a lowered position. The paddles are about as wide as the tray 30. A linear actuator, such as a hydraulic or pneumatic cylinder or leadscrew, moves each paddle 69 between the raised and lowered positions. A cylinder may be double acting, or single acting with a spring return. While seed is deposited as the seed head 64 traverses the tray 30, one or both paddles 69 are lowered to a height above the tray that is a preset height, such as a height that is slightly greater than the height of a deposited seed. After the seed head 64 completes a full traverse, the paddles 69 are raised to allow indexing the next tray to position for seeding. The seed head 64 may traverse alternately from side to side. As the seed head 64 travels from right to left, the right paddle 69 may be lowered and the left paddle 69 raised. When traveling from left to right, the left paddle 69 may be lowered and the right paddle 69 raised. Illustratively, FIG. 11 conceptually illustrates a seed head 64 with no paddles 69 deployed (i.e., lowered) in configuration A, with one paddle 69 deployed (i.e., lowered) in configuration B; and both paddles 69 deployed in configuration C. Thus, the seeding zone is provided for depositing seeds in a tray using a seeding head, and automatically doing so with a linearly moving seeding head positioned above the tray, and maintaining a substantially single layer of deposited seed by extending at least one paddle downwardly toward the surface of the tray, with a difference between the free end of the paddle and the surface of the tray on which seed is deposited being about the height of a single layer of deposited seed. In this manner, less seed is wasted.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A hydroponic system for automatically growing and harvesting sprouts, the system comprising:
a framework including a left side and a right side,
a first chain driven in a first serpentine path along one of the left side and right side, the first chain being a first continuous chain, and
a plurality of first side chain rails, each first side chain rail of the plurality of first side chain rails defining a portion of the first serpentine path, and
a plurality of trays operably coupled to the first chain, each tray being substantially parallel to each other tray, each tray having a length, and each tray being between the left side and right side of the framework, and each tray being spaced apart from each other tray, and movement of the first chain along the first serpentine path causing movement of each tray along the first serpentine path, and
the first serpentine path including a seeding zone, and a seed head automatically depositing seeds on each tray as the tray passes through the seeding zone, the seed head traveling linearly, the entire length of the tray, along a guide above each tray as the tray passes through the seeding zone, and depositing a layer of seed along the entire length of each tray as the tray passes through the seeding zone, a first paddle extending downardly from the seed head, the paddle including a free end, a space between the free end of the paddle and the tray defining a height of the layer of deposited seed.

2. The hydroponic system for automatically growing and harvesting sprouts according to claim 1, each tray including a first side and an opposite second side, the first side being at a higher elevation than the second side, the tray being inclined, and the tray including at least one drainage aperture at the second side.

3. The hydroponic system for automatically growing and harvesting sprouts according to claim 1, the first serpentine path further comprising a growing zone, and the system further comprising at least one nozzle in the growing zone, the nozzle delivering a liquid nutrient to each tray as the tray passes through the growing zone.

4. The hydroponic system for automatically growing and harvesting sprouts according to claim 1, the first serpentine path further comprising a harvesting zone and the system further including a tipping device causing each tray to tip as the tray passes through the harvesting zone, and upon tipping dropping any sprouts from the tray.

5. The hydroponic system for automatically growing and harvesting sprouts according to claim 4, the system further comprising a chute for receiving sprouts dropped from each tray in the harvesting zone.

6. The hydroponic system for automatically growing and harvesting sprouts according to claim 4, the system further comprising a conveyor for receiving sprouts dropped from each tray in the harvesting zone.

7. The hydroponic system for automatically growing and harvesting sprouts according to claim 1, the first serpentine path further comprising a growing zone and the system further comprising electric lighting within the growing zone.

8. The hydroponic system for automatically growing and harvesting sprouts according to claim 1, the system further comprising a plurality of support pins, each of the plurality of trays being operably coupled to the first chain by at least one of the plurality of support pins, each support pin extending from the first chain.

9. The hydroponic system for automatically growing and harvesting sprouts according to claim 1, the system further comprising a second chain driven in a second serpentine path along the other of the left side and right side, the second chain being a second continuous chain, and the second chain moving in unison with the first chain, and the second serpentine path being a mirror image of the first serpentine path, and
a plurality of second side chain rails, each second side chain rail of the plurality of second side chain rails being substantially parallel to one of first side chain rails and defining a portion of the second serpentine path.

10. The hydroponic system for automatically growing and harvesting sprouts according to claim 9, the plurality of trays operably coupled to the second chain, and movement of the first chain and second chain along the first serpentine path and second serpentine path, respectively, causing movement of each tray along the first serpentine path and second serpentine path.

11. The hydroponic system for automatically growing and harvesting sprouts according to claim 10, the system further comprising a plurality of first side sprockets and a plurality of second side sprockets, the first chain being trained over the plurality of first side sprockets and the second chain being trained over the plurality of second side sprockets.

12. The hydroponic system for automatically growing and harvesting sprouts according to claim 11, the system further comprising a motor operably coupled to a drive shaft, the drive shaft including a first drive sprocket and a second drive sprocket, the first chain being trained over the first drive sprocket and driven by the first drive sprocket, the second chain being trained over the second drive sprocket and driven by the second drive sprocket in unison with the first chain driven by the first drive sprocket.

13. The hydroponic system for automatically growing and harvesting sprouts according to claim 2, the seed head moving between the first side of each tray and the second side of each tray while the tray is in the seeding zone, and the seed head depositing a layer of seeds on the tray while the seed head moves between the first side of each tray and the second side of each tray.

14. The hydroponic system for automatically growing and harvesting sprouts according to claim 11, the seed head further comprising at least one paddle, the paddle being movable from a raised position to a lowered position, the lowered position defining a seeding space between each tray in the seeding zone and the paddle, the seeding space allowing a layer of seeds on the tray.

15. The hydroponic system for automatically growing and harvesting sprouts according to claim 11, the seed head further comprising a pair of paddles, each paddle being independently movable from a raised position to a lowered position, the lowered position defining a seeding space between each tray in the seeding zone and the paddle, the seeding space allowing a layer of seeds on the tray.

16. The hydroponic system for automatically growing and harvesting sprouts according to claim 1, the first serpentine path further comprising a preparation zone and the system further comprising a tipping device causing each tray to tip as the tray passes through the preparation zone, and the system further comprising a cleaning head, the cleaning head delivering a cleaning liquid to each tray when the tray is tipped in the preparation zone.

17. The hydroponic system for automatically growing and harvesting sprouts according to claim 14, the system further comprising a receptacle for collecting cleaning liquid dripped from each tray when the tray is tipped in the preparation zone.

18. The hydroponic system for automatically growing and harvesting sprouts according to claim 14, the first serpentine path further comprising a growing zone, and the system further comprising at least one nozzle in the growing zone, the nozzle delivering a liquid nutrient to each tray as the tray passes through the growing zone, and the system further comprising a plurality of containers of nutrients fluidly coupled to the nozzle.

19. A hydroponic system for automatically growing and harvesting sprouts, the system comprising:
a framework including a left side and a right side,
a first chain driven in a first serpentine path along one of the left side and right side, the first chain being a first continuous chain, and
a plurality of first side chain rails, each first side chain rail of the plurality of first side chain rails defining a portion of the first serpentine path, and
a plurality of trays operably coupled to the first chain, each tray being substantially parallel to each other tray, each tray having a length, and each tray being between the left side and right side of the framework, and each tray being spaced apart from each other tray, and movement of the first chain along the first serpentine path causing movement of each tray along the first serpentine path, each tray including a first side and an opposite second side, the length of each tray being the distance from the first side to the opposite second side, the first side being at a higher elevation than the second side, the tray being inclined, and the tray including at least one drainage aperture at the second side, and
the first serpentine path including a seeding zone, and a seed head automatically depositing seeds on each tray as the tray passes through the seeding zone, the seed head traveling linearly, the entire length of the tray, along a guide above each tray as the tray passes through the seeding zone, and depositing seed along the entire length of each tray as the tray passes through the seeding zone, and
a second chain driven in a second serpentine path along the other of the left side and right side, the second chain being a second continuous chain, and the second chain moving in unison with the first chain, and the second serpentine path being a mirror image of the first serpentine path, and
a plurality of second side chain rails, each second side chain rail of the plurality of second side chain rails being substantially parallel to one of first side chain rails and defining a portion of the second serpentine path, the plurality of trays operably coupled to the second chain, and movement of the first chain and second chain along the first serpentine path and second serpentine path, respectively, causing movement of each tray along the first serpentine path and second serpentine path, and
a plurality of first side sprockets and a plurality of second side sprockets, the first chain being trained over the plurality of first side sprockets and the second chain being trained over the plurality of second side sprockets, and
a motor operably coupled to a drive shaft, the drive shaft including a first drive sprocket and a second drive sprocket, the first chain being trained over the first drive sprocket and driven by the first drive sprocket, the second chain being trained over the second drive sprocket and driven by the second drive sprocket in unison with the first chain driven by the first drive sprocket.

20. The hydroponic system for automatically growing and harvesting sprouts according to claim 19, the first serpentine path further comprising a harvesting zone and the system further including a tipping device causing each tray to tip as the tray passes through the harvesting zone, and upon tipping dropping any sprouts from the tray, and
the seed head depositing a single layer of seeds on each tray while the tray is in the seeding zone, the seed head including a spreader paddle protruding downwardly towards each tray while the tray is in the seeding zone, the distance between the spreader paddle and the tray being adjustable to about a height of a single layer of seeds.
